(19) United States
(12) Patent Application Publication
(10) Pub. No.: US 2026/0279029 A1
(43) Pub. Date: Sep. 17, 2026

(54) SYSTEM AND METHOD FOR REDUCING FALSE POSITIVES IN OBJECT DETECTION FRAMEWORKS

(71) Applicant: CARNEGIE MELLON UNIVERSITY, Pittsburgh, PA (US)

(72) Inventors: Marios Savvides, Pittsburgh, PA (US); Uzair Ahmed, Pittsburgh, PA (US)

(73) Assignee: CARNEGIE MELLON UNIVERSITY, Pittsburgh, PA (US)

(21) Appl. No.: 19/667,980

(22) Filed: May 5, 2026

Related U.S. Application Data
(63) Continuation of application No. 18/273,183, filed on Feb. 16, 2022, now Pat. No. 12,639,937.
(60) Provisional application No. 63/149,823, filed on Feb. 16, 2021.

(51) Int. Cl. G06V 10/778; G06V 10/75

(52) U.S. Cl. CPC G06V 10/7788; G06V 10/757

(57) ABSTRACT

Disclosed herein is a system and method for reducing false positives in object detection frameworks. During a gallery creation mode, the false positives gallery is formed or updated. A human reviews objects detected by the object detection framework and indicates whether the object is an object of a class for which the object detection framework is trained to detect and if it has been classified correctly. When an indication of a false positive been received, a feature representation of displayed object is stored in the false positives gallery. During an inference or testing mode, the false positives gallery is searched for a feature representation matching the feature representation of the detected objects, and, if a match is found, the detected object is deemed to be a false positive and is not identified as an object for which the object detection framework has been trained to detect.

### RELATED APPLICATIONS

This application is a continuation application filed under 35 U.S.C. § 120 of U.S. patent application Ser. No. 18/273,183, filed Jul. 19, 2023, which is a filing under 35 U.S.C. § 371 of International Patent Application No. PCT/US2022/016510, filed Feb. 16, 2022, which claims the benefit of U.S. Provisional Patent Application No. 63/149,823, filed Feb. 16, 2021, the contents of which are incorporated herein in their entireties.

### BACKGROUND

Deep neural networks trained as object detection models may often return false positive results. A false positive result occurs when the model labels or classifies an object in an image when it should not have. For example, classifying an image of a cat as a dog.

In a deep neural network, an object detection model will take an image as input and will typically place bounding boxes around detected objects for which the object detection model has been trained to detect and classify. At a high level, the objects are detected by comparing a feature representation of the object with feature maps in the model. Features may be extracted from each object in bounding box by a trained feature extractor. A classifier may then return a probability that a feature representation represents an object that the classifier was trained to classify and return a positive result if the probability exceeds a certain threshold. Thus, an object having an appearance similar to the target object may generate a false positive.

In the context of object detection and classification, it is naturally desirable to reduce the occurrence of false positive results to the greatest extent possible. This may be critical in certain applications, for example, wherein the object detector is examining medical specimens for evidence of objects representing disease conditions or in certain applications for autonomous vehicle operation.

### SUMMARY

Disclosed herein is a system and method for reducing false positives in object detection frameworks. The method is designed to work with any configuration of a deep CNN model and can work without any explicit model retraining. In this method, a human-in-the-loop review is performed to determine if a detected object is a false positive. If an indication is received from the user of a false positive, a feature representation of the object (from, e.g. CNN trained as a feature extractor), that can be used for matching the object to another feature representation is added to a false positives gallery. In testing, if a similar feature representation from a similar object is matched against any feature representation stored in the false positives gallery, then the prediction is determined to be a false positive, without any kind of model re-training, and the prediction will not be presented to the user, thus maintaining or improving the perception of the user that the system is performing satisfactorily.

### BRIEF DESCRIPTION OF THE DRAWINGS

By way of example, a specific exemplary embodiment of the disclosed system and method will now be described, with reference to the accompanying drawings, in which:

FIG. 1 is a flow diagram showing a process of the method during the inference mode of operation.

FIG. 2 is a flow diagram showing the process of user review and updating of the false positives gallery.

FIG. 3 is a schematic representation of the flow of a system implementing the claimed methods.

### DETAILED DESCRIPTION

The disclosed invention addresses the problem of suppressing false positive detection results by building a false positives gallery on the fly through a Human-In-The-Loop (HITL) strategy during a gallery creation mode. The human-in-the-loop manually audits the output of the object detection model to identify the false positives and their respective feature representations are added to the feature false positives gallery. After a substantial amount of enrollment of feature representations from false positives, the gallery creation mode of the process completes and an inference (testing) mode begins, without the intervention of an HITL.

If the performance during the inference mode falls below a pre-determined threshold or if there is an increased observation of false positive detections, the system toggles back to the gallery creation mode from the inference mode until satisfactory performance is met and sustained for a certain amount of time. On success, the process toggles back into the inference mode.

To suppress the false positive results, the corresponding feature representation of each detected bounding box result is matched with all of the feature representations in the false positives gallery. If a match is found, then the particular feature representation of the detection result is suppressed and not displayed to the end user. If the feature representation of the detected bounding box is not found in the false positives gallery, then the result is displayed and, if the method is operating in the gallery creation mode, is followed by manual human audit. The system toggles from the inference mode to the gallery creation mode when the performance is unsatisfactory (i.e., for example, when the percentage of false positives rises above a threshold, leading to user dissatisfaction) and from the gallery creation mode to the inference mode after additional training. Note that training, in this context, refers to the addition of more feature representations to the false positives gallery, not necessarily retraining of the classifier.

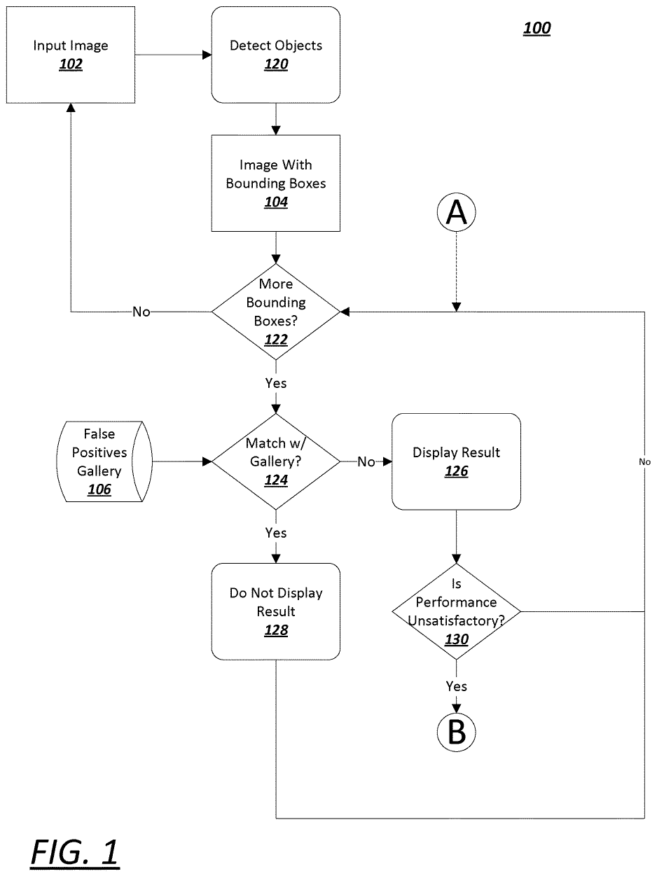

FIG. 1 is a flowchart showing the steps of process 100 for the inference mode of operation of the method. This flowchart assumes that false positives gallery 106 has already been created during a gallery creation mode, which is discussed later.

During process 100, an input image 102 is input to an object detection model which is typically a deep convolutional neural network (CNN). At step 120, objects for which the object detection model has been trained to detect that are depicted in image 102 are detected and classified. This results in an image 104 having bounding boxes enclosing the detected objects in image 102. The rest of the process of inference mode 100 is iterated for each bounding box in image 104.

At decision point 122, it is determined if there are more bounding boxes in image 104 that need to be processed and, if not, a new input image 102 is obtained. If there are more bounding boxes in image 104, a feature representation of one of the objects in a bounding box is attempted to be matched, at decision point 124, with feature representations in false positives gallery 106. In other words, feature galley 106 is searched for a match for the feature representation of the object. The feature representations in false positives gallery 106 are representative of false positives previously detected by the object detection model.

In one embodiment, cosine similarity can be used for matching. A predefined threshold is set, and if the similarity is more than the threshold, a match is confirmed.

At decision point 124, if there are no matches between the current feature representation and the feature representations stored in false positives gallery 106, then the object is displayed at step 126. If the current feature representation, at decision point 124, does match with a feature presentation stored in false positives gallery 106, then, at step 128, the result is not displayed, as it has now been identified as a false positive and control returns to 122, where it is determined if more objects were detected in the input image 104.

If, at decision point 124, there is no match and the result is displayed at 126, the displayed result may still be a false positive (but its feature representation may not be in the false positives gallery).

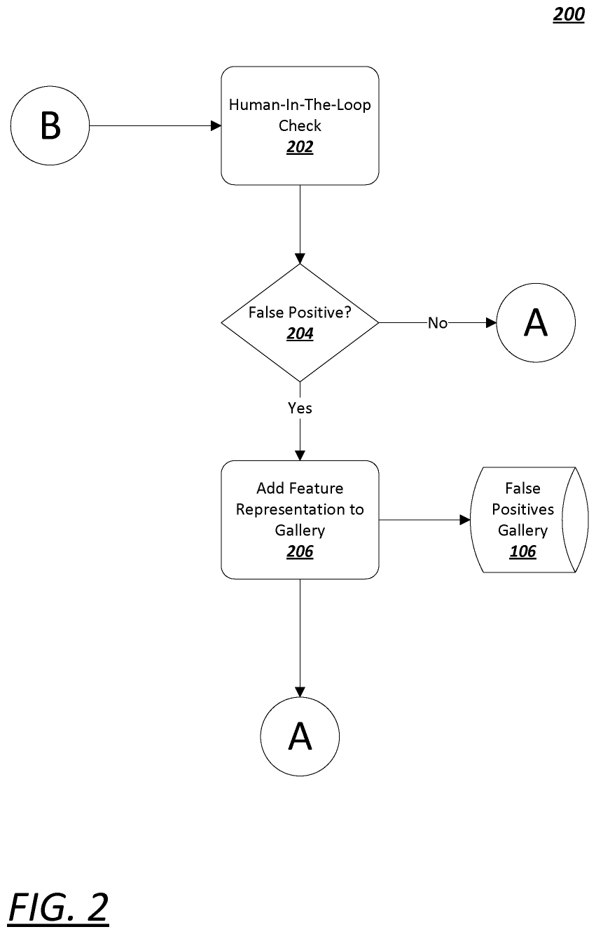

At decision point 130, a decision is made as to whether the performance of the model has become unsatisfactory. The determination of whether the performance has become unsatisfactory may be made manually by a user or may be algorithmically determined using some metric. The performance may be deemed to be unsatisfactory if, for example, the percentage of false positives displayed rises above a predetermined threshold. In any case, if the performance has been deemed to be unsatisfactory, then, at step 132, the method proceeds to gallery creation mode at “B” in FIG. 2. If the performance is satisfactory, then control returns to decision point 122, where it is determined if there are more bounding boxes in image 104 that need to be processed.

In gallery creation mode, at decision point 124, if the current feature representation does not match any feature representations stored in false positives gallery 106 then the result is displayed at step 126 and, if the performance is still unsatisfactory at 130, control proceeds to entry point “B” in FIG. 2, which depicts the human-in-the-loop review process 200.

FIG. 2 shows the steps of the HITL review process 200 of the method. At step 202, an HITL check is performed on the object that was displayed at step 126 of process 100 of FIG. 1. The HITL check at step 202 has a user manually indicating whether the displayed result is a false positive. The detected object may be false positive if the object is identified by the object detection model as belonging to a class for which the object detection model was trained to classify, but the displayed result does not actually depict an object in that class.

If the user indicates that the result is a false positive at decision point 204 then, at step 206, the feature representation of the object is added to false positives gallery 106 and control returns to entry point “A” in FIG. 1, where, at decision point 120, it is determined if more bounding boxes are present in the current image 104.

If, at decision point 204, the user indicates that the displayed result is not a false positive, control proceeds to entry point “A” in FIG. 1 without adding the feature representation of the displayed result to the false positives gallery 106. When a sufficient number of additional results have been evaluated by the user, the gallery creation mode is toggled off and the method proceeds in the inference mode in accordance with process 100 depicted in FIG. 1. The number of additional results necessary to be evaluated by the user to improve accuracy of the object detection model may be determined by the user or may be deterred algorithmically.

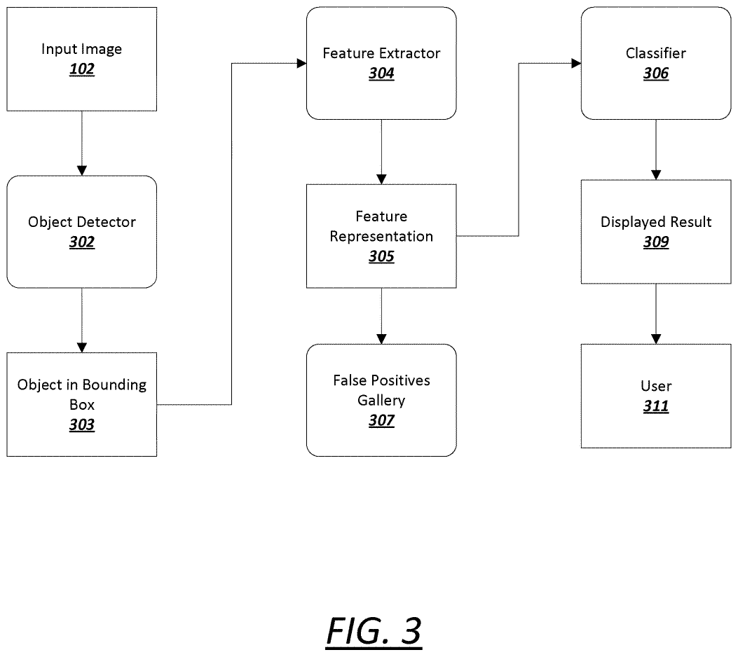

FIG. 3 is a schematic representation of the flow of a system implementing the claimed methods. Image 102 is input to object detector 302, which outputs the image annotated with bunding boxes around the objects. For each object in a bounding box 303, feature extractor 304 extracts feature representation 305 of the object. The feature representation 305 is matched with feature representations stored in false positives gallery 307. If a match is found, the result is simply not displayed. This may indicate that the object is not an object for which the system has been trained to classify. The feature representation 305 is fed to classifier 306 if no match is found in the false positives gallery 307. If classifier 306 is able classify the feature representation 305 as an object for which the classifier 306 is trained to classify, the result 309 is displayed. In gallery creation mode, user 311 may review the displayed result 309 to determine if the classification is accurate, and if not, the feature representation 305 is added to the false positives gallery 307. In inference mode, a user 311 may also review the displayed result 309 to determine if the performance of the system is satisfactory.

As would be realized, the method must initially be run in gallery creation mode to establish the initial false positives gallery used by the method in inference mode.

The method disclosed herein may be used by any object detection model to improve the accuracy and reduce the incidence of false positives produced by the model. The object detector, feature extractor and classifier may be separate components or may be combined into one component.

As would be realized by one of skill in the art, the disclosed method described herein can be implemented by a system comprising a processor and memory, storing software that, when executed by the processor, performs the functions comprising the method.

As would further be realized by one of skill in the art, many variations on implementations discussed herein which fall within the scope of the invention are possible. Moreover, it is to be understood that the features of the various embodiments described herein were not mutually exclusive and can exist in various combinations and permutations, even if such combinations or permutations were not made express herein, without departing from the spirit and scope of the invention. Accordingly, the method and apparatus disclosed herein are not to be taken as limitations on the invention but as an illustration thereof. The scope of the invention is defined by the claims which follow.

1. A method for improving performance of an object detection and classification model comprising:
obtaining an image annotated by the model having bounding boxes enclosing detected objects in the image;
for each bounding box in the image:
obtaining, from the model, a feature representation of the object enclosed in the bounding box;
searching feature representations stored in a false positives gallery for a match with the feature representation of the object enclosed in the bounding box; and
displaying the result when no matches are found between the feature representation of the object and feature representations stored in the false positives gallery.

2. The method of claim 1 further comprising:
not displaying the result when a match is found between the feature representation of the object and feature representations stored in the false positives gallery.

3. The method of claim 1 further comprising:
determining that the performance of the object detection model is unsatisfactory; and
initiating a gallery creation mode of the method wherein each displayed result is confirmed by the user.

4. The method of claim 3 further comprising:
displaying the result;
receiving, from a user, an indication that the result is correct.

5. The method of claim 3 further comprising:
displaying the result;
receiving, from a user, an indication that the result is incorrect; and
adding the feature representation of the object to the false positives gallery.

6. A method for improving performance of an object detection and classification model comprising:
obtaining an image annotated by the model having bounding boxes enclosing detected objects in the image;
for each bounding box in the image:
obtaining, from the model, a feature representation of the object enclosed in the bounding box;
searching feature representations stored in a false positives gallery for a match with the feature representation of the object enclosed in the bounding box;
displaying the result when no matches are found between the feature representation of the object and feature representations stored in the false positives gallery;
receiving, from a user, an indication that the display result does not match the object; and
storing the feature representation of the object in the false positives gallery.

7. The method of claim 1 wherein a match between the feature representations in the false positives gallery and the feature representation of the object enclosed in the bounding box is determined using cosine similarity.

8. The method of claim 7 wherein the match 1is determined when the cosine similarity exceeds a predetermined threshold.

9. The method of claim 2 wherein a match is found between the feature representation of the object and feature representations stored in the false positives gallery when the difference between the feature representation of the object and a feature representation in the false positives gallery is smaller than a predetermined threshold.

10. A system comprising:
a processor; and
a method, storing software that, when executed by the processor,
performs the steps of the method of claim 1.

11. A system comprising:
a processor; and
a method, storing software that, when executed by the processor, performs the steps of the method of claim 6.

12. A system comprising:
an object detector configured to detect objects in an image;
a feature extractor configured to extract feature representation of the detected objects;
a classifier configured to classify the feature representations; and
a false positives gallery, containing feature representations of had been previously classified incorrectly;
wherein each feature representation is matched against feature representations contained in the false positives gallery to determine if the feature representation had previously been classified incorrectly.

13. The system of claim 12 wherein a feature representation of a detected object is determined to match a feature representation stored in the false positives gallery when the difference between the feature representation of the detected object and a feature representation in the gallery falls below a predetermined threshold.
